(19) United States
(12) Patent Application Publication
(10) Pub. No.: US 2010/0233432 A1
(43) Pub. Date: Sep. 16, 2010

(54) IMPRINT METHOD AND PROCESSING METHOD OF SUBSTRATE

(75) Inventors: Shingo Okushima, Tokyo (JP); Junichi Seki, Yokohama-shi (JP); Haruhito Ono, Minamiashigara-shi (JP); Nao Nakatsuji, Kawasaki-shi (JP)

Correspondence Address: FITZPATRICK CELLA HARPER & SCINTO, 1290 Avenue of the Americas, NEW YORK, NY, 10104-3800, US

(73) Assignee: Canon Kabushiki Kaisha, Tokyo (JP)

(21) Appl. No.: 12/281,685

(22) PCT Filed: Aug. 1, 2008
(86) PCT No.: PCT/JP2008/064259

§ 371 Date: Sep. 4, 2008

(30) Foreign Application Priority Data
Aug. 3, 2007 (JP) 2007-203044
Jul. 14, 2008 (JP) 2008-182301

(51) Int. Cl. B32B 3/30; B29C 59/02

(52) U.S. Cl. 428/156; 264/132

(57) ABSTRACT

An imprint method in which imprinting of a pattern of a mold onto a resin material on a substrate is repeated multiple times. The imprint method includes the steps of preparing the mold including a light blocking member at a position where the pattern is not formed, forming a pattern for the first time by bringing the mold into contact with a photocurable resin material provided on the substrate, forming a first processed area by curing the photocurable resin material by light irradiation, and removing a part of the photocurable resin material extruded from the first processed area into an outside area at a periphery of the first processed area.

### TECHNICAL FIELD

The present invention relates to an imprint method for imprinting a pattern of a mold onto a resin material layer and a method of processing a substrate.

### BACKGROUND ART

In recent years, fine processing technology for transferring a fine structure of a mold onto a member, such as a resin material, a metal material, or the like, has been developed and has received attention (Stephan Y. Chou et al., Appl. Phys. Lett., Vol., 67, Issue 21, pp. 3114-3116 (1995)). This technology is called nanoimprint or nanoembossing and provides a resolution on the order of several nanometers. For this reason, the technology has been increasingly expected to be applied to next-generation semiconductor manufacturing technologies in place of light exposure devices, such as a stepper, a scanner, and the like. Further, the technology is capable of collectively processing a three-dimensional structure at a wafer level, so that the technology has been expected to be applied to a wide variety of fields, such as manufacturing technologies for optical devices, such as photonic crystal, and biochips, such as μ-TAS (Micro Total Analysis System).

In the case where such processing technology is applied to semiconductor manufacturing, the processing is performed in the following manner.

A work (workpiece) including a substrate (e.g., a semiconductor wafer) and a photocurable resin material layer disposed on the substrate and a mold on which a desired imprint (projection/recess) pattern is formed are disposed opposite to each other and between the work and the mold, the resin material is filled, followed by irradiation of ultraviolet (UV) light to cure the resin material.

By this process, the above-mentioned pattern is transferred onto the resin material layer and then etching or the like is effected by using the resin material layer as a mask, so that pattern formation on the substrate is performed.

In the case where the (nano-)imprint is used as a lithographic method for semiconductor manufacturing, a step-and-repeat method in which a transfer onto a substrate repeatedly performed by using a mold smaller in size than the substrate is suitable (T. Bailey et al., J. Vac. Sci. Technol. B, Vol. 18, No. 6, pp. 3572-3577 (2000)). This is because it is possible to improve the accuracy by reducing an integral error of alignment and the mold pattern itself due to an increase in wafer size, and it is possible to reduce the production cost of the mold increased by the increase in wafer size.

However, the above-described imprint method has a problem in that it is difficult to produce a device that is larger in a size than the mold.

That is, as shown in FIG. 10, when the imprint for one shot is performed in the case where the pattern is formed on a substrate 5203 by processing the substrate 5203, a resin material 5202 can be pushed out of a shot area to form an outside area 5204 along an edge of a mold 5201. The thus formed outside area 5204 has a width, which is generally larger than the size of the pattern or a period of the pattern. Further, the thickness of the resin material layer in the outside area 5204 is larger than that in the shot area (processed area) 5205 in many cases. For example, the thickness of the resin material layer and an unevenness of the pattern in the processed area 5205 is about several tens of nm to about several hundreds of nm, whereas the thickness of the resin material layer in the outside area 5204 can be several μm or more.

In such an outside area 5204, it is difficult to form the pattern. Therefore, a gap corresponding to at least the width of the outside area 5204 is created between adjacent shot areas. As a result, it is difficult to produce a large-size device by connecting patterns transferred from the pattern of the mold. Further, even in the case where the large-size device is not produced, there arises such a problem that the number of chips prepared from one wafer is decreased by the presence of the outside area 5204 to increase the production cost.

### DISCLOSURE OF THE INVENTION

In view of the above-described problem, a principal object of the present invention is to provide an imprint method capable of connecting patterns of adjacent processed areas to each other to reduce the production cost.

Another object of the present invention is to provide a method of processing a substrate using the imprint method.

According to the present invention, it is possible to realize an imprint method capable of connecting patterns of adjacent processed areas to each other to reduce the production cost. It is also possible to realize a substrate processing method using the imprint method.

These and other objects, features, and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a flow chart of an imprint method in Embodiment 1 of the present invention.

FIGS. 2(a) to 2(e) are schematic views for illustrating a removal step of a resin material in an outside area in Embodiment 1 of the present invention.

FIGS. 3(a) to 3(c) are schematic views for illustrating a pattern forming step performed for the second time using a mold having a structure for blocking light emitted to a part of the resin material extruded into a periphery of a processed area in Embodiment 1 of the present invention.

FIGS. 4(a) to 4(c) are schematic views for illustrating an arrangement of processed areas in respective transfer steps in an imprint method for repeating a pattern forming step in Embodiment 1 of the present invention.

FIGS. 5(a) to 5(c) are schematic views for illustrating a method of transferring a pattern onto a substrate in Embodiment 1 of the present invention.

FIGS. 6(a) and 6(b) are schematic views for illustrating the connection of the pattern in Embodiment 1 of the present invention.

FIGS. 7(a) to 7(d) and FIGS. 8(a) and 8(b) are schematic views for illustrating arrangements of processed areas in Embodiment 2 of the present invention.

FIGS. 9(a) to 9(d) are schematic views for illustrating substrate processing in Embodiment 2 of the present invention.

FIG. 10 is a schematic view for illustrating a problem in a conventional substrate processing method using imprint technology.

### BEST MODE FOR CARRYING OUT THE INVENTION

Embodiments of the present invention will be described.

In the embodiments of the imprint method according to the present invention, when a pattern of a mold is imprinted, a pattern forming step in which a processed area is formed and a resin material in an outside area is removed is repeated multiple times. In second or subsequent transfer steps, a part of the resin material extruded from the processed area into the outside area at a periphery of the processed area formed in a first transfer step is removed from the outside area and a subsequent pattern transfer is performed in a processed area, which overlaps with the outside area.

When a plurality of processed areas are formed in the above-described processed area with respect to at least one of a first direction and a second direction perpendicular to the first direction by the imprint method performed multiple times in the first transfer step, an interval between adjacent processed areas of the plurality of processed areas is an integral multiple of the width of each processed area. Thus, it is possible to perform an imprint method capable of easily transferring a pattern onto a resin material not only in the processed area, but also in the outside area onto which the resin material is extruded from the processed area to eliminate or decrease an interval between adjacent shot areas (adjacent processed areas), and this method is capable of connecting patterns in the adjacent shot areas to each other.

Further, in the embodiments of the processing method according to the present invention, in succession to the removal step of the resin material in the outside area, it is possible to process the substrate by using the pattern formed on the resin material on the substrate through the transfer of the pattern of the mold. Herein, the substrate means a member to be processed including not only a single substrate, such as a silicon wafer, but also a multi-layer substrate on which multiple films are formed.

Hereinbelow, embodiments of the present invention will be described with reference to the drawings. Identical or corresponding portions in the respective figures are represented by identical reference numerals or symbols.

### Embodiment 1

In Embodiment 1, an imprint method according to the present invention will be described.

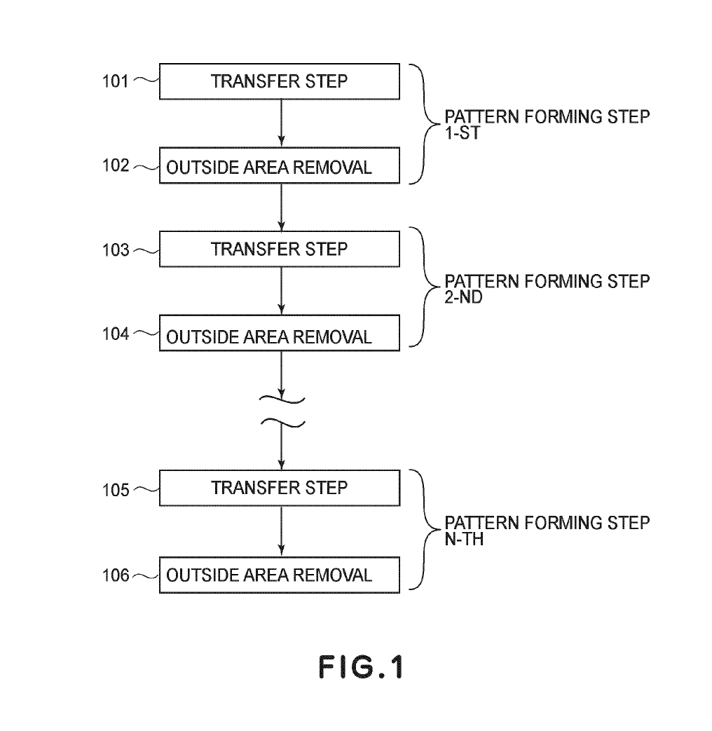

FIG. 1 is a flow chart of the imprint method in this embodiment.

Step 101 is a first transfer step in which imprint for transferring a pattern of a mold onto a resin material layer formed on a substrate is performed once or plural times by the step-and-repeat method to form a first processed area.

Step 102 is a first removal step in which the resin material extruded in step 101 from the first processed area into a peripheral portion in an outside area is removed. A first pattern is formed by this process.

The pattern forming step in this embodiment is, as described above, consists of a series of the transfer step and the removal step for removing the resin material layer in the outside area after the transfer step.

Step 103 is a second transfer step for forming a second processed area. In this step, an imprint step is performed so that the second processed area overlaps with the outside area from which the resin material layer is removed in step 102.

Step 104 is a second removal step in which the resin material extruded from the second processed area into a peripheral portion in an outside area in step 103 is removed. A second pattern is formed by this process.

By repeating multiple times the pattern forming step consisting of the series of the transfer step and the removal step also in a third pattern forming step or later, it is possible to transfer the pattern onto the resin material layer even in the already created outside area.

In FIG. 1, step 105 is an N-th transfer step and step 106 is an N-th removal step.

In an embodiment described later, the case of performing the pattern forming step three times will be described.

Next, imprint steps in this embodiment will be specifically described.

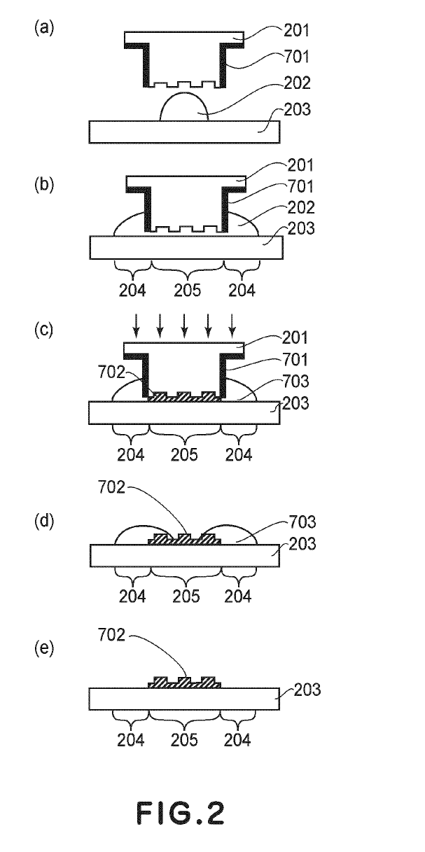

FIGS. 2(a) to 2(e) are schematic views for illustrating the imprint steps in this embodiment.

First, in a step as shown in FIG. 2(a), a resin material layer 202 is formed on a substrate 203. Thereafter, in a step shown in FIG. 2(b), a mold 201 and is brought into contact with the resin material layer 202 to fill the resin material between the mold 201 and the substrate 203. At this time, a part of the resin material layer 202 pressed out of a processed area 205 by the mold 201 is formed in an outside area (extrusion area) 204.

The light blocking film 701 is a film for blocking light so that the resin material layer 202 in the outside area 204 is not cured by light irradiation and is provided to the mold 201 at a position where the pattern of the mold 201 is not formed. The resin material layer 202 is formed from a photocurable resin material. Next, in a step shown in FIG. 2(c), the resin material layer 202 is cured by irradiation with ultraviolet (UV) rays or the like from a back surface side of the mold 201. The mold 201 is provided with the light blocking film 701, so that it is possible to cure only a resin material layer 702 in the processed area 205 and place a resin material layer 703 in the outside area 204 in an uncured state. Then, in a step shown in FIG. 2(d), the mold 201 is separated from the resin material layer 702 and the uncured resin material layer 703, so that the pattern on the mold 201 is transferred onto the resin material layer 702.

Then, as shown in FIG. 2(e), only the resin material layer 703 in the outside area 204 can be removed by using a solvent, such as acetone or the like.

In this embodiment, the mold 201 has a desired pattern at its surface and is formed of a material such as silicon, quartz, or sapphire. The surface where the pattern is formed is generally subjected to parting processing using a fluorine-based silane coupling agent or the like. Herein, the mold having such a parting layer formed by the parting processing is inclusively referred to as the “mold”.

As a material for the resin material layer 202, it is possible to employ an acrylic or epoxy photocurable resin material or the like.

To form the resin material layer 202 on the substrate 203, it is possible to use an ink jet method, a dropwise application method using a dispenser, a spin coating method, or the like.

The light blocking film 701 may be a metal film, such as a Cr film, formed by sputtering, chemical vapor deposition (CVD), vacuum deposition, and ion plating. The light blocking film 701 may also be a film that does not completely block light capable of curing the photocurable resin material. In this case, the film may be required only to provide a necessary difference in the degree of curing between an area in which the light is not blocked and an area in which the light is blocked.

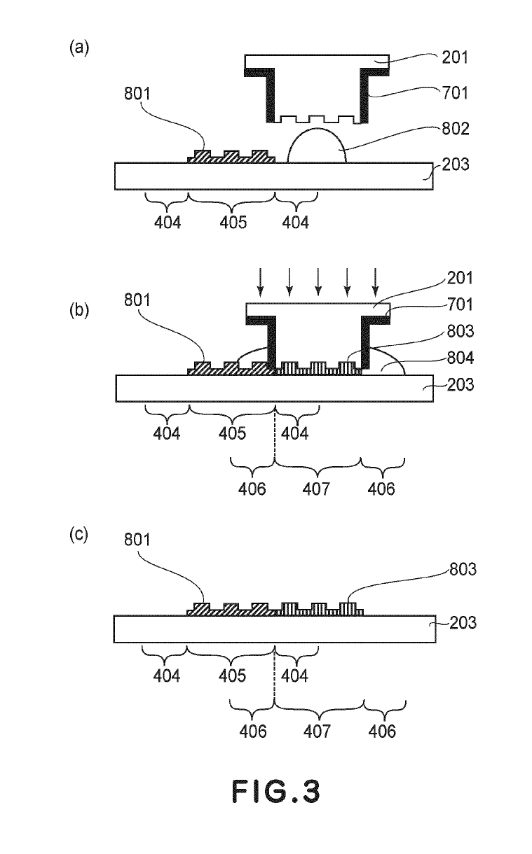

FIGS. 3(a) to 3(c) are schematic views for illustrating a second pattern forming step using a mold having a structure for blocking light emitted to the resin material extruded into the periphery of the processed area.

In FIG. 3(a), a resin material layer 802 for a second transfer step is disposed in an area adjacent to a resin material layer 801 formed in the first transfer step.

At this time, it is necessary to dispose the resin material layer 802 and the mold 201 so that a processed area 407 in an imprint step of a second transfer step overlaps with the outside area 404 in the first transfer step.

In FIG. 3(b), the mold 201 is brought into contact with the resin material layer 802 and a resultant resin material layer 803 is irradiated with light from a back surface side of the mold 201, so that the resin material layer 803 formed in a processed area 407 in the second transfer step is cured. A resin material layer 804 formed in an outside area 406 in the second transfer step by using the light blocking film 701 is not cured. In FIG. 3(b), when the mold 201 is brought into contact with the resin material layer 802, a part of the resin material layer 804 in an outside area 406 is also located on the resin material layer 801 in the processed area 405. However, the resin material layer 801 has already been cured in the first pattern forming step, so that the resin material layer 801 is not mixed with the uncured resin material layer 804. As a result, it is possible to remove only the resin material layer in the outside area.

Similarly, in a third pattern forming step, a pattern is transferred in a state in which a third processed area is superposed on the outside area in the preceding step, and then only the resin material layer in the outside area is removed.

Through the above-described steps, as shown in FIG. 3(b), it is possible to form the resin material layer on the substrate 203, onto which a desired pattern is transferred.

As described above, by using a removing method using the mold provided with the light blocking film, it is possible to reduce (eliminate) the gap between adjacent processed areas and connect the patterns in the adjacent processed areas. In this case, it is possible to remove the resin material layer in the outside area only by dissolving the resin material layer in a solvent. For this reason, it is possible to prevent substrate damage during the resin material layer removal in the outside area.

Next, the imprint method for performing the pattern forming step three times will be described more specifically.

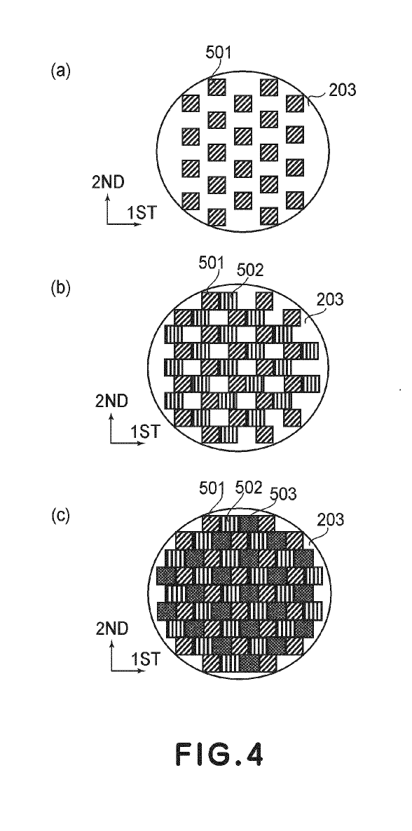

FIGS. 4(a) to 4(c) are top views for illustrating the arrangement of processed areas in transfer steps in the imprint method for performing the pattern forming step three times. Reference numeral 501 represents a processed area (first processed area) in a first transfer step, reference numeral 502 represents a processed area (second processed area) in a second transfer step, and reference numeral 503 represents a processed area (third processed area) in a third transfer step.

FIG. 4(a) shows an arrangement of the processed area (first processed area) in the first transfer step in a first pattern forming step. With respect to the arrangement in a first direction (1ST) in FIG. 4(a), an interval between adjacent processed areas with respect to the first direction is an integral multiple, e.g., two times, of the width of the processed area with respect to the first direction. The “two times” the width of the processed area means “two times” the width of the processed area to which an adjusting amount for the sum of a mold processing error and a mold alignment error is added, and this definition is also applicable to the following description.

With respect to the arrangement in a second direction (2ND) perpendicular to the first direction (1ST), each processed area is moved in the first direction by a distance that is equal to the processed area width and is moved in the second direction by a distance which is, e.g., 1.5 times the processed area width. The distance of the movement of each processed area in the second direction is not limited to 1.5 times the processed area width, but is at least a distance that is the sum of the processed area width and a width of the outside area and, at most, a distance obtained by subtracting the outside area width from a length, which is two times the processed area width.

FIG. 4(b) shows an arrangement of the processed areas 502 in the second transfer step in a second pattern forming step. With respect to the first direction in FIG. 4(b), the processed areas 502 are disposed adjacently to the processed areas 501 arranged in the first transfer step.

FIG. 4(c) shows an arrangement of the third processed areas 503 in the third transfer step in a third pattern forming step. With respect to the first direction in FIG. 4(c), the third processed areas 503 in the third transfer step are disposed between the first processed areas 501 and the second processed areas 502 in the first and second transfer steps.

By arranging the processed areas as in this embodiment, it is possible to transfer a pattern onto substantially the entire substrate 203 by repeating the pattern forming step three times.

Also, in the case of repeating the pattern forming step three times or more, an interval between adjacent processed areas of the plurality of processed areas is set to a length obtained by multiplying a length of the processed area width by the number of repeated pattern forming steps performed after completion of the first pattern forming step, so that the pattern can be similarly transferred onto substantially the entire substrate. However, generally, in the transfer step and the removal step in the pattern forming step, an apparatus used is required to be exchanged. For this reason, in order to improve throughput of the processing method, the number of repeatedly performed pattern forming steps is preferably be small.

By arranging the processed areas as in this embodiment, it is possible to reduce a gap between adjacent processed areas with respect to all the adjacent processed areas and connect patterns of all the processed areas to each other by repeating the pattern forming step only three times.

FIGS. 4(a) to 4(c) merely illustrate an example of this embodiment. Therefore, the number of imprint steps in each transfer step or the like varies depending on sizes or shapes of the mold and the substrate.

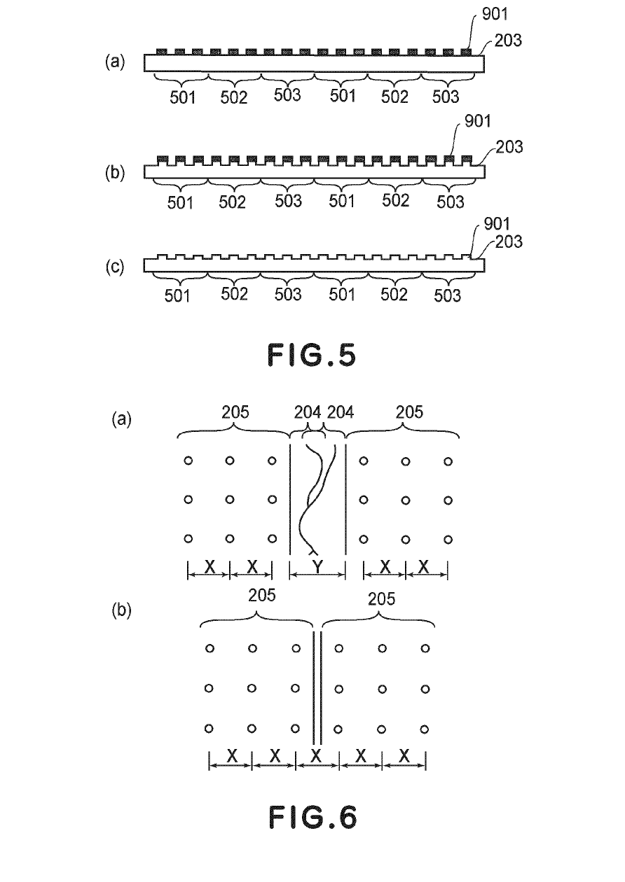

In this embodiment, it is also possible to transfer the pattern onto the substrate 203 through the resin material layer on which the pattern is transferred as the mask. FIGS. 5(a) to 5(c) are sectional views for illustrating a method therefor.

The resin material layer transferred on the substrate has a portion that is generally called the residual film as a ground work for the pattern.

FIG. 5(a) shows a resin material layer 901 after the residual film of the resin material layers 801, 803 and the like is removed. That is, this figure shows the structure at a stage in which the thickness of the resin material layer on the entire substrate surface is uniformly reduced by etching of the resin material layer until the residual film is eliminated from the state of the resin material layer shown in FIG. 4(b). Next, by using the remaining resin material layer 901 as the mask, the substrate is etched to reach a state shown in FIG. 5(b). Finally, by removing the remaining resin material layer 901, as shown in FIG. 5(c), it is possible to transfer a desired pattern onto the substrate.

When a dot pattern with a pitch of X is transferred in the processed area 205, a state shown in FIG. 6(a) can be reached if the present invention is not applied. That is, when a width between adjacent processed areas in the outside area 204 is Y, the pitch is Y or more. In the case where Y is larger than X, it is difficult to set the pitch between the adjacent processed areas such as to be X.

To the contrary, in the present invention, as shown in FIG. 6(b), the pattern can also be formed in the outside area to bring the adjacent processed areas closer to each other so that the pitch of the dot pattern between the adjacent processed areas can be set to X.

As described above, in this embodiment, it is possible to connect the patterns of the adjacent processed areas to each other. Such a processing method can be suitably used for a structure, such as a photonic crystal, so that a refractive index distribution is arranged periodically with respect to an in-plane direction.

As the connectable pattern, in addition to the dot pattern, it is also possible to employ other patterns, such as a line-and-space pattern, a hole pattern, and a free pattern.

Further, in this embodiment, the shape of the mold in the processed area is not limited to a square. Various shapes, such as a hexagon, may be used.

Further, it is also possible to connect the patterns without using the light blocking film.

That is, a first protection layer for protecting a first processed area is formed on the first processed area, and a resin material layer in an outside area is removed while a pattern formed on a resin material layer in the processed area is protected by the first protection layer so as not to be removed. Next, a mold is brought into contact with a resin material layer formed in an area that includes an outside area and is adjacent to the first processed area to form a second processed area.

Then, on the resin material layer in the second processed area, a second protection layer for protecting the second processed area is formed.

Finally, the resin material is extruded from the second processed area onto a periphery of the second processed area while the patterns formed on the resin material layers in the first and second processed areas are protected by the first and second protection layers so as not to be removed.

In this way, the resin material is applied onto a substrate and imprinting with the mold is performed once or multiple times to form the first processed area, and the resin material extruded into the periphery of the first processed area is removed to form a pattern for the first time. Then, a pattern may be formed for the second time by repeating the same step as in the first pattern forming step in the area that includes the outside area and is adjacent to the first processed area.

### Embodiment 2

In Embodiment 2, an method of arranging processed areas different from that in Embodiment 1 will be described.

The difference of this embodiment from Embodiment 1 is in the manner in which the processed areas are arranged in each of transfer steps, and therefore, only the difference will be explained.

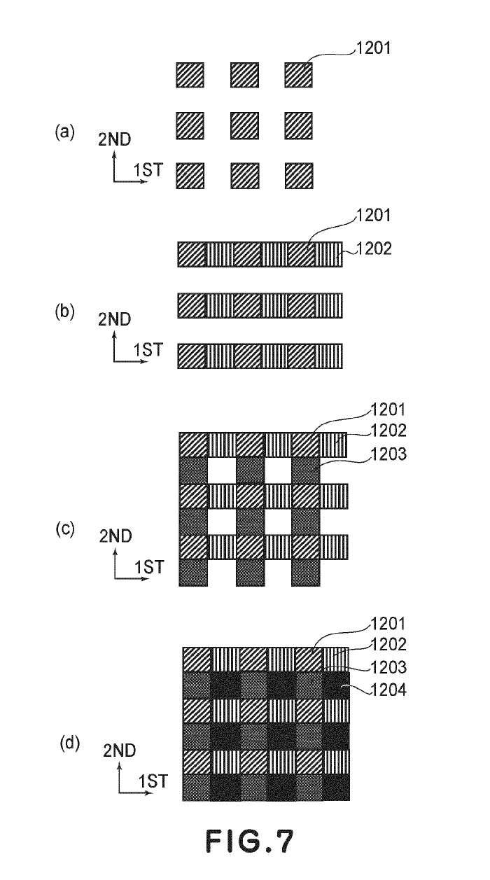

With reference to FIGS. 7(a) to 7(d), a method of repeating the pattern forming step four times will be described.

Reference numeral 1201 represents a processed area in a first transfer step, reference numeral 1202 represents a processed area in a second transfer step, reference numeral 1203 represents a processed area in a third transfer step, and reference numeral 1204 represents a processed area in a fourth transfer step.

First, as shown in FIG. 7(a), in the first transfer step, pattern transfer in the processed area 1201 is performed with an arrangement period of the processed areas 1201, which is two times the processed area width both with respect to the first direction and the second direction. Thereafter, the removal step is performed.

Next, as shown in FIG. 7(b) and FIG. 7(c), in the second transfer step and the third transfer step, a pattern is transferred in the processed area 1202 between horizontal adjacent processed areas 1201 and in the processed area 1203 between vertical adjacent processed areas 1201, respectively. Thereafter, the corresponding removal step is performed.

Finally, as shown in FIG. 7(d), in the remaining processed area 1204, a pattern is transferred in the fourth transfer step. Thereafter, the removal step is performed.

In the method in which the pattern forming step is repeated three times, edges of the processed areas cannot be aligned with respect to either one of the first direction and the second direction. In the method in which the pattern forming step is repeated four times, the edges of the processed areas can be aligned with respect to both the first direction and the second direction.

That is, this is possible even in the case where it is necessary to align the edges of the processed areas with respect to both the first direction and the second direction, e.g., in the case of dicing the substrate along the edges of the processed areas into a mesh-like shape.

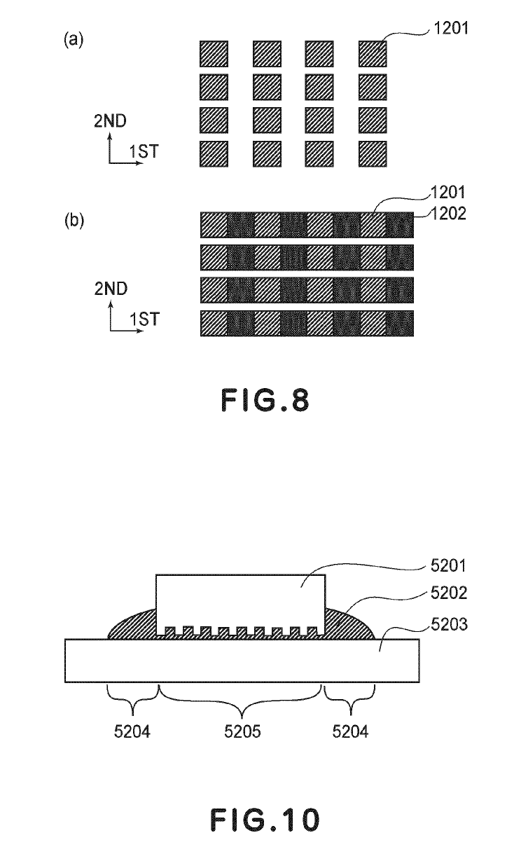

A method of repeating the pattern forming step two times will be described with reference to FIGS. 8(a) and 8(b).

As shown in FIG. 8(a), in a first transfer step, pattern transfer in a processed area 1201 is performed with an arrangement period of the processed areas 1201, which is two times the processed area width with respect to the first direction, and with an appropriate interval between adjacent processed areas with respect to the second direction. Thereafter, the removal step is performed. The appropriate interval is such that there is no overlap of the outside area with an adjacent processed area.

Next, as shown in FIG. 8(b), in a second transfer step, a pattern is transferred in the processed areas 1202 between adjacent processed areas 1201 with respect to the first direction in the first transfer step. Thereafter, the removal step is performed.

Through the above-described steps, in the case where it is necessary to connect transfer patterns of the respective processed areas to each other only with respect to one direction, it is possible to transfer the pattern repeating the pattern forming step only two times.

In the present invention, the number of times the pattern forming step and the processed area arranging method are repeated, and the shape of the mold in the processed area are not limited to those described above.

### Embodiment 3

In Embodiment 3, a method of arranging processed areas different from those of Embodiments 1 and 2 will be described.

Embodiment 3 is different from Embodiments 1 and 2 in a structure of the mold used in each of the transfer steps, and therefore, only the difference will be described.

In the present invention, the same mold is not necessarily used in the respective transfer steps. That is, e.g., in the method of repeating the pattern forming step four times in Embodiment 2, it is also possible to use different molds in the first to fourth transfer steps, respectively.

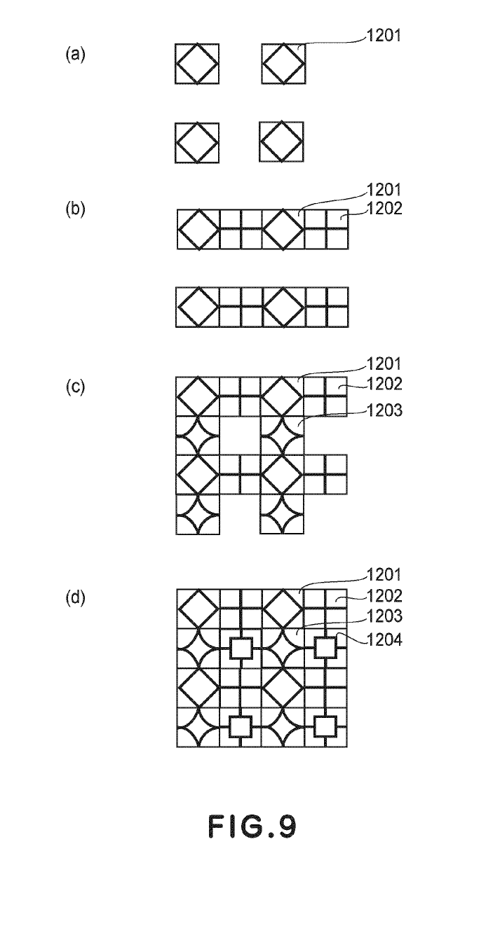

FIG. 9(a) shows a stage after the first transfer step is completed.

FIG. 9(b) shows a stage after the second transfer step is completed. The mold used in the second transfer step has a pattern different from that of the mold used in the first transfer step.

FIG. 9(c) shows a stage after the third transfer step is completed. The mold used in the third transfer step has a pattern different from those of the molds used in the first and second transfer steps.

FIG. 9(d) shows a stage after the fourth transfer step is completed. The mold used in the fourth transfer step has a pattern different from those of the molds used in the first to third transfer steps.

When the mold having the same pattern is used in all the transfer steps, only a pattern with a period corresponding to one processed area at most can be transferred. However, as in this embodiment, the molds having different patterns are used in the transfer steps, respectively, so that it is possible to transfer a pattern having a four-time periodic structure.

As described above, in this embodiment, the mold having a different pattern is used in each of the respective transfer steps, so that it is possible to transfer a pattern with a larger period.

### INDUSTRIAL APPLICABILITY

According to the present invention, it is possible to provide an imprint method capable of connecting patterns of adjacent processed areas to each other to reduce production cost. It is also possible to provide a method of processing a substrate using the imprint method.

While the invention has been described with reference to the structures disclosed herein, it is not limited to the details set forth, and this application is intended to cover such modifications or changes as may come within the purpose of the improvements or the scope of the following claims.

1. An imprint method in which a step of forming a pattern by imprinting a pattern of a mold onto a resin material on a substrate is repeated multiple times, said imprint method comprising:
a step of preparing the mold including a light blocking member at a position in which the pattern is not formed;
a step of forming a pattern for a first time through steps including a step of bringing the mold into contact with a photocurable resin material provided on the substrate, a step of forming a first processed area by curing the photocurable resin material through light irradiation, and a step of removing a part of the photocurable resin material extruded from the first processed area into an outside area at a periphery of the first processed area: and
a step of forming a pattern for a second time through steps including a step of bringing the mold into contact with a photocurable resin material provided on the substrate in an area which includes the outside area and is adjacent to the first processed area, a step of forming a second processed area by curing the photocurable resin material in the area, and a step of removing a part of the photocurable resin material extruded from the second processed area at a periphery of the second processed area.

2. A method according to claim 1, wherein in said step of forming the pattern for the first time, when a plurality of processed areas is formed in the first processed area with respect to at least one of a first direction and a second direction perpendicular to the first direction, an interval between adjacent processed areas of the plurality of the processed areas is an integral multiple of a length of a width of each processed area.

3. A method according to claim 2, wherein the length of the width of each processed area includes a length corresponding to an adjusting amount including a processing error of the mold and an alignment error between the substrate and mold.

4. A method according to claim 2, wherein said step of forming the pattern is repeated three times, and
wherein said imprint method further comprises:
a step of forming each of the processed areas so that an interval between adjacent processed areas of the plurality of processed areas formed in the first processed area with respect to the first direction is two times a length of a width of the first processed area and the processed areas with respect to the second direction are disposed so as not to be adjacent to each other; and
a step of forming a third processed area in an area adjacent to the second processed area after said step of forming the pattern for the second time.

5. A method according to claim 1, wherein when the step of forming the pattern is repeated multiple times, different molds are used in said steps of forming the patterns, respectively.

6. A processing method for processing a substrate, comprising:
a step of processing the substrate with a pattern, imprinted on a resin material on the substrate by an imprint method according to claim 1, as a mask.

7. A structure produced by using a processing method of a substrate according to claim 6.

8. An imprint method in which a step of forming a pattern by imprinting a pattern of a mold onto a resin material on a substrate is repeated multiple times, said imprint method comprising:
a step of forming a pattern for a first time by applying a resin material onto the substrate, forming a first processed area through imprint with the mold performed one time or multiple times, and removing a part of the resin material extruded from the first processed area into an outside area at a periphery of the first processed area; and then
a step of forming a pattern for a second time by repeating the same step as said first step in an area which includes the outside area and is adjacent to the first processed area.
